(19) United States
(12) Patent Application Publication
(10) Pub. No.: US 2015/0153874 A1
(43) Pub. Date: Jun. 4, 2015

(54) ELECTRODE PLATE OF CAPACITIVE TOUCH PANEL, TOUCH PANEL AND TOUCH CONTROL DISPLAY APPARATUS

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Hongjuan Liu, Beijing (CN); Haisheng Wang, Beijing (CN); Junwei Wu, Beijing (CN)

(21) Appl. No.: 14/344,817

(22) PCT Filed: May 22, 2013
(86) PCT No.: PCT/CN2013/076086

§ 371 Date: Mar. 13, 2014

(30) Foreign Application Priority Data
Mar. 15, 2013 (CN) 201310084440.5

(51) Int. Cl. G06F 3/044

(52) U.S. Cl. CPC G06F 3/044; G09G 2300/0426

(57) ABSTRACT

Embodiments of the present invention disclose an electrode plate of capacitive touch panel, a touch panel and a touch control display apparatus. The electrode plate is an ITO electrode plate, includes conductive channels and ITO lines, and at least one of the channels connects at least two of the ITO lines, The touch panel comprises the described electrode plate. The touch control display apparatus includes the described touch panels. In the embodiments, the reliability of the use of the touch panel can be improved, and even if a circuit open happens in the ITO electrodes, the touch panel can operate normally.

### TECHNICAL FIELD

Embodiments of the present invention relate to an electrode plate of a capacitive touch panel, a touch panel and a touch control display apparatus.

### BACKGROUND

With the wide use of tablet personal computers, the technology of touch panel is developed quickly. For the design of a conventional touch panel, the pattern of the touch panel, i.e., the layout of indium tin oxide (ITO) electrode wiring of an ITO electrode plate are shown in FIGS. 3 and 4. Whatever patterns of the configuration of the conventional wiring layout of the ITO electrode are, each conductive channel is connected to one ITO line. Thus, when a circuit open happens in the ITO electrode for one channel, the whole touch panel cannot run smoothly, such that the stability of the use of the touch panel is reduced significantly.

### SUMMARY

Main objects of embodiments of the present invention are to provide an electrode plate of capacitive touch panel, a touch panel, and a touch control display apparatus, which can increase the reliability of the use of the touch panel, and therefore even if a circuit open happens in the ITO electrodes, the touch panel can operate smoothly.

To achieve one of the above objects, the technical solutions of the embodiments of the present invention are described below.

An electrode plate of capacitive touch panel, wherein the electrode plate is an ITO electrode plate, comprises conductive channels and ITO lines, and at least one of the channels is connected to at least two of the ITO lines.

The channels and the ITO lines include the channels and the ITO lines provided along a first direction, and at least every two of the ITO lines connect to one of the channels in the first direction.

The channels and the ITO lines include the channels and the ITO lines provided along a second direction intersecting the first direction, at least every two of the ITO lines connect to one of the channels in the second direction, and the ITO lines along the first direction are insulated from the ITO lines along the second direction.

If the ITO electrodes have a wiring layout in a web pattern, it is adaptable to a multi-layers configuration, and if the ITO electrodes have a wiring layout in a diamond or strip pattern, it is adaptable to a single-layer configuration.

Each of the ITO lines has a width which is half of that of a conventional ITO line.

A touch panel includes the above described electrode plates.

A touch control display apparatus includes the above described touch panels.

In the embodiments of the present invention, one channel connects at least two of the ITO lines and the at least two of the lines can provide protection for each other, such that the whole touch panel can operate smoothly, and the reliability of the use of the touch panel can be improved.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic diagram of the wiring layout of ITO electrodes in an embodiment of the present invention;

FIG. 2 is another schematic diagram of the wiring layout of ITO electrodes in an embodiment of the present invention;

FIG. 3 is a schematic diagram of the wiring layout of ITO electrodes in conventional ITO electrodes; and

FIG. 4 is another schematic diagram of the wiring layout of ITO electrodes in conventional ITO electrodes.

### DETAILED DESCRIPTION OF THE PREFERRED EMBODIMENTS

In order to make objects, technical details and advantages of the embodiments of the invention apparent, technical solutions according to the embodiments of the present invention will be described clearly and completely as below in conjunction with the accompanying drawings of embodiments of the present invention. It is to be understood that the described embodiments are only a part of but not all of exemplary embodiments of the present invention. Based on the described embodiments of the present invention, various other embodiments can be obtained by those of ordinary skill in the art without creative labor and those embodiments shall fall into the protection scope of the present invention.

Unless otherwise defined, all the technical and scientific terms used herein have the same meanings as commonly understood by one of ordinary skill in the art to which the present invention belongs. The terms, such as “first,” “second,” or the like, which are used in the description and the claims of the present application, are not intended to indicate any sequence, amount or importance, but for distinguishing various components. Also, the terms, such as “a/an,” “one,” or the like, are not intended to limit the amount, but for indicating the existence of at lease one. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not intended to define a physical connection or mechanical connection, but may include an electrical connection/coupling, directly or indirectly. The terms, “on,” “under,” “left,” “right,” or the like are only used to indicate relative position relationship, and when the position of the object which is described is changed, the relative position relationship may be changed accordingly.

The basic concept of the embodiments of the present invention lies in that the configuration of the ITO wiring layout of ITO electrodes allows at least one channel to be connected to at least two ITO lines, in the electrode plate of a capacitive touch panel, or a touch panel, such as projected capacitive electrode plate or a touch panel.

The implementation of the technical solutions will be described in detail hereunder in connection to the accompanying drawings.

An electrode plate of a capacitive touch panel is provided, the electrode plate is an ITO electrode plate, the configuration of the ITO wiring layout of the ITO electrodes involves at least one channel being connected to at least two ITO lines.

Further, at least every two of the ITO lines provided in a first direction are connected to one of the channels.

Further, at least every two of the ITO lines provided in a second direction intersecting the first direction are connected to one of the channels, and the ITO lines provided along the first direction are insulated from the ITO lines provided along the second direction.

In the embodiment of the present invention, at least two ITO lines are connected to one channel. In contrast, one channel is connected to one ITO line in the conventional technology. As such, in the embodiment of the present invention, the at least two ITO lines can provide protection for each other, i.e., if one of the ITO lines connected to each of the channel goes wrong, which allows a circuit open to happen in the ITO electrode, the other of the ITO lines connected to each of the channel can work to conduct immediately. That is to say, the other ITO line is still conductive, and the related channel can operate normally, so does the touch panel. In this way, it can be ensured that the whole touch panel runs normally and the reliability of the use of the touch panel can be improved due to the two ITO lines protecting each other.

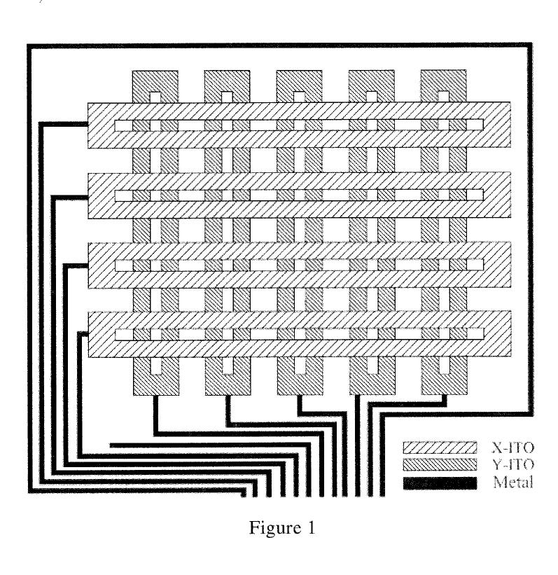

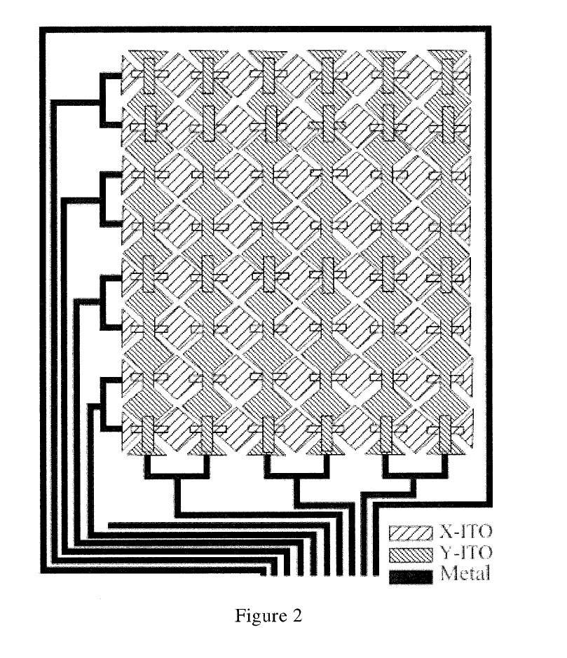

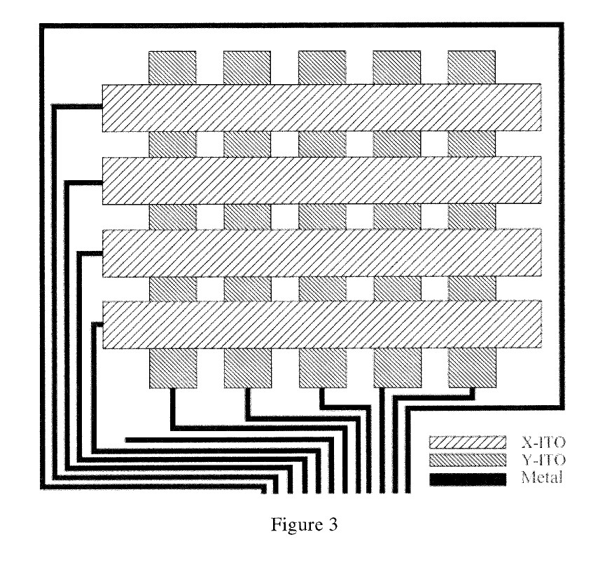

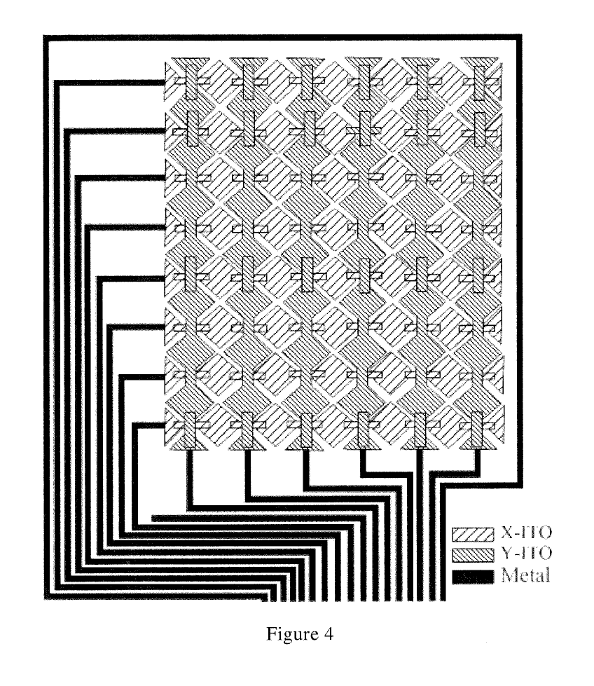

FIGS. 1 and 2 are schematic diagrams of the wiring layout of ITO electrodes in embodiments of the present invention. The wiring layout of the ITO electrodes in FIG. 1 is in a web pattern. Compared with the configuration of the conventional technology as shown in FIG. 3, each of the ITO lines has a width which is about half of the width of the conventional ITO line, and the configuration of FIG. 1 is adaptable to a multi-layer configuration. The wiring layout of the ITO electrodes as shown in FIG. 2 is in a diamond pattern; compared with the configuration of the conventional technology as shown in FIG. 4, each of the ITO lines has a width which is about half of the width of the conventional ITO line, and the configuration of FIG. 2 is adaptable to a single-layer configuration. The wiring layout of an embodiment of the present invention can also be in a strip pattern, and it is also adaptable to a single-layer configuration, which is not described in detail here.

Specifically, the web configuration adaptable to multi-layer ITO configuration includes at least two layers of ITO films, and the diamond or strip pattern adaptable to a single-layer ITO configuration includes a single layer of ITO film. Whatever is the configuration type, it is needed to connect the ITO electrode(s) in the X (transverse) direction or the Y (longitudinal) direction by means of bridging. The ITO lines connected with different channels arranged along the X direction are insulated from the ITO lines connected with different channels arranged along the Y direction. The processes for the web configuration adaptable to a multi-layers ITO configuration are relatively complicated, while the processes for the diamond or strip pattern adaptable to a single-layer ITO configuration are relatively simple.

In the embodiments of the present invention, with the above described two types of configurations, the overlapping area and the face-to-face area between the ITO electrodes along the X direction and the Y direction in the ITO electrode plate are enlarged, i.e., the mutual capacitance between the ITO electrodes along the X direction and the ITO electrodes along the Y direction is increased. The embodiments of the present invention can improve the reliability of the use of the touch panel, and also can improve the detect sensibility of a touch IC because the detecting principle of a touch IC is detecting the change of the capacitance of the panel before and after a user's finger touches the panel. Compared with the conventional pattern, the pattern configuration of the embodiments of the present invention has increased overlapping and face-to-face area, i.e., the mutual capacitance between the ITO electrodes along the X direction and the ITO electrodes along the Y direction is enlarged. As such, the number of the adsorbed charges is increased when a user's finger touches the panel, which facilitates the sensing of the touch point and improves the detect sensibility of the touch IC accordingly.

An embodiment of the present invention provides a touch panel including the above described ITO electrode plate. The ITO electrode plate of the embodiments of the present invention is adaptable to various pattern designs of touch panels, such as SITO, DITO, GIF, and G2F of any touch panel configuration.

An embodiment of the present invention further provides a touch control display apparatus including the described touch panel(s).

The above described are only exemplary implementations of the present invention, and not intended to limit the protection scope of the present invention. The scope of the present invention is defined by the appended claims.

1. An electrode plate of capacitive touch panel, wherein the electrode plate is an Indium Tin Oxide (ITO) electrode plate comprising conductive channels and ITO lines, and at least one of the conductive channels are connected to at least two of the ITO lines.

2. The electrode plate according to claim 1, wherein the channels and the ITO lines comprise the channels and the ITO lines provided along a first direction, and at least every two of the ITO lines connect to one of the channels in the first direction.

3. The electrode plate according to claim 2, wherein the channels and the ITO lines comprises the channels and the ITO lines provided along a second direction intersecting the first direction, at least every two of the ITO lines connect to one of the channels in the second direction, and the ITO lines provided along the first direction are insulated from the ITO lines provided along the second direction.

4. The electrode plate according to claim 1, wherein the ITO electrodes have a wiring layout in a web pattern adaptable to a multi-layers configuration.

5. The electrode plate according to claim 1, wherein the ITO electrodes have a wiring layout in a diamond or strip pattern adaptable to a single-layer configuration.

6. A touch panel comprises the electrode plate according to claim 1.

7. A touch control display apparatus comprises the touch panel according to claim 6.

8. The electrode plate according to claim 2, wherein the ITO electrodes have a wiring layout in a web pattern adaptable to a multi-layers configuration.

9. The electrode plate according to claim 2, wherein the ITO electrodes have a wiring layout in a diamond or strip pattern adaptable to a single-layer configuration.

10. The electrode plate according to claim 3, wherein the ITO electrodes have a wiring layout in a web pattern adaptable to a multi-layers configuration.

11. The electrode plate according to claim 3, wherein the ITO electrodes have a wiring layout in a diamond or strip pattern adaptable to a single-layer configuration.
